(19) United States
(12) Patent Application Publication
(10) Pub. No.: US 2026/0094231 A1
(43) Pub. Date: Apr. 2, 2026

(54) Cache traffic based reduction of ray tracing hardware state

(71) Applicant: Advanced Micro Devices, Inc., Santa Clara, CA (US)

(72) Inventors: Carsten Benthin, Voelklingen (DE); Michael John Livesley, Edinburgh (GB)

(21) Appl. No.: 18/898,876

(22) Filed: Sep. 27, 2024

(51) Int. Cl. G06T 1/60; G06T 15/06

(52) U.S. Cl. CPC G06T 1/60; G06T 15/06

(57) ABSTRACT

An apparatus and method for efficiently managing ray tracing to reduce cache contention are contemplated. In various implementations, a computing system includes a host processing circuit sending commands of a video graphics application to a parallel data processing circuit. The cache memory subsystem of the parallel data processing circuit stores copies of data used for ray tracing operations. A cache access monitor tracks cache access metrics such as cache misses, cache evictions, and cache access latencies of the cache memory subsystem. A control circuit controls a number of rays that can be sent to the ray tracing circuit from compute circuits of the parallel data processing circuit. The control circuit uses the monitored cache access metrics to reduce or increase the number of rays being processed or serviced at any given time.

### BACKGROUND

### Description of the Relevant Art

Highly parallel data applications are used in a variety of fields such as science, entertainment, finance, medical, engineering, social media, and so on. With an increased number of processing circuits in computing systems, the latency to deliver data to the processing circuits becomes emphasized. The performance, such as throughput, of the processing circuits depends on quick access to stored data. When performing ray tracing operations, various acceleration structures (data structures) are used to increase processing speed. A ray tracing circuit uses such structures to identify intersections of simulated light rays and objects in a scene of a video frame. To do so, the ray tracking circuit receives, from a parallel data processing circuit, data corresponding to simulated light rays (or rays) originating from a source, such as a point of view of a camera, and traveling in a particular direction.

The ray tracing circuit tracks paths within the scene of the image data until the ray intersects with an object in the scene. Rays that are closely related in various ways are considered coherent. These rays may be closely related temporally, spatially, directionally, or otherwise. Such rays typically require the common data and it is more likely that required data will have been cached when processing such rays. Rays that are not so closely related, are considered “incoherent” as these may not generally require common data. When processing incoherent rays, the likelihood of cache misses and evictions is increased which reduces performance of the system.

In view of the above, methods and mechanisms for efficiently managing ray tracing to reduce cache contention are desired.

### BRIEF DESCRIPTION OF THE DRAWINGS

FIG. 1 is a generalized diagram of a computing system that efficiently manages ray tracing to reduce cache contention.

FIG. 2 is a generalized diagram of an apparatus that efficiently manages ray tracing to reduce cache contention.

FIG. 3 is a generalized diagram of a method for efficiently managing ray tracing to reduce cache contention.

FIG. 4 is a generalized diagram of a method for efficiently managing ray tracing to reduce cache contention.

FIG. 5 is a generalized diagram of a computing system that efficiently manages ray tracing to reduce cache contention.

FIG. 6 is a generalized diagram of a method for efficiently managing ray tracing to reduce cache contention.

FIG. 7 is a generalized diagram of a method for efficiently managing ray tracing to reduce cache contention.

FIG. 8 is a generalized diagram of a method for efficiently managing ray tracing to reduce cache contention.

FIG. 9 is a generalized diagram of a method for efficiently managing parallel data processing to reduce cache contention.

While the invention is susceptible to various modifications and alternative forms, specific implementations are shown by way of example in the drawings and are herein described in detail. It should be understood, however, that drawings and detailed description thereto are not intended to limit the invention to the particular form disclosed, but on the contrary, the invention is to cover all modifications, equivalents and alternatives falling within the scope of the present invention as defined by the appended claims.

### DETAILED DESCRIPTION

In the following description, numerous specific details are set forth to provide a thorough understanding of the present invention. However, one having ordinary skill in the art should recognize that the invention might be practiced without these specific details. In some instances, well-known circuits, structures, and techniques have not been shown in detail to avoid obscuring the present invention. Further, it will be appreciated that for simplicity and clarity of illustration, elements shown in the figures have not necessarily been drawn to scale. For example, the dimensions of some of the elements are exaggerated relative to other elements.

Apparatuses and methods for efficiently managing ray tracing to reduce cache contention are contemplated. In various implementations, a computing system includes multiple processing circuits. A host processing circuit of the multiple processing circuits is a general-purpose processing circuit, such as a central processing unit (CPU). Another processing circuit of the multiple processing circuits is a parallel data processing circuit with a highly parallel data microarchitecture. Examples of this processing circuit are a graphics processing unit (GPU), a digital signal processing circuit (DSP), a field programmable gate arrays (FPGA), and an application specific integrated circuit (ASIC). In various implementations, the host processing circuit converts (translates) the instructions of a highly parallel data application, such as a video graphics application, to commands. The host processing circuit stores the commands in a buffer in system memory. The compute circuits of the parallel data processing circuit reads the commands from the buffer and generates ray data during video graphics processing. Circuitry controls the number of rays that can be conveyed to the ray tracing circuit from the compute circuits. The ray tracing manager circuit uses monitored cache access metrics to set the number.

Typically, there is no way to dynamically control the number of rays being sent from the compute circuits to the ray tracing circuit to account for cache contention. When processing incoherent rays (e.g., for intersection testing), the likelihood of cache contention is increased, which reduces performance for one or more processes using the cache memory subsystem. To reduce cache contention and potentially improve performance, the number of rays conveyed to the ray tracing circuitry can be reduced. Reducing the number of rays being processed by the ray tracing circuitry reduces the likelihood of cache contention. In various implementations, the cache memory subsystem of the parallel data processing circuit stores copies of an acceleration structure (e.g., a bounding volume hierarchy) to be used for ray tracing operations. Monitoring circuitry tracks various cache related metrics such as cache miss rate, a cache eviction rate, and an average cache access latency, and so on. The ray data manager circuit (control circuit) controls data transfer of ray data and ray intersection data between the parallel data processing circuit and a ray tracing circuit based on feedback from the cache access monitor. For example, when the feedback indicates there is cache contention (or a threshold level of cache contention has been reached), fewer rays are conveyed to the ray tracing circuitry for processing. Further detail is provided in the following discussion.

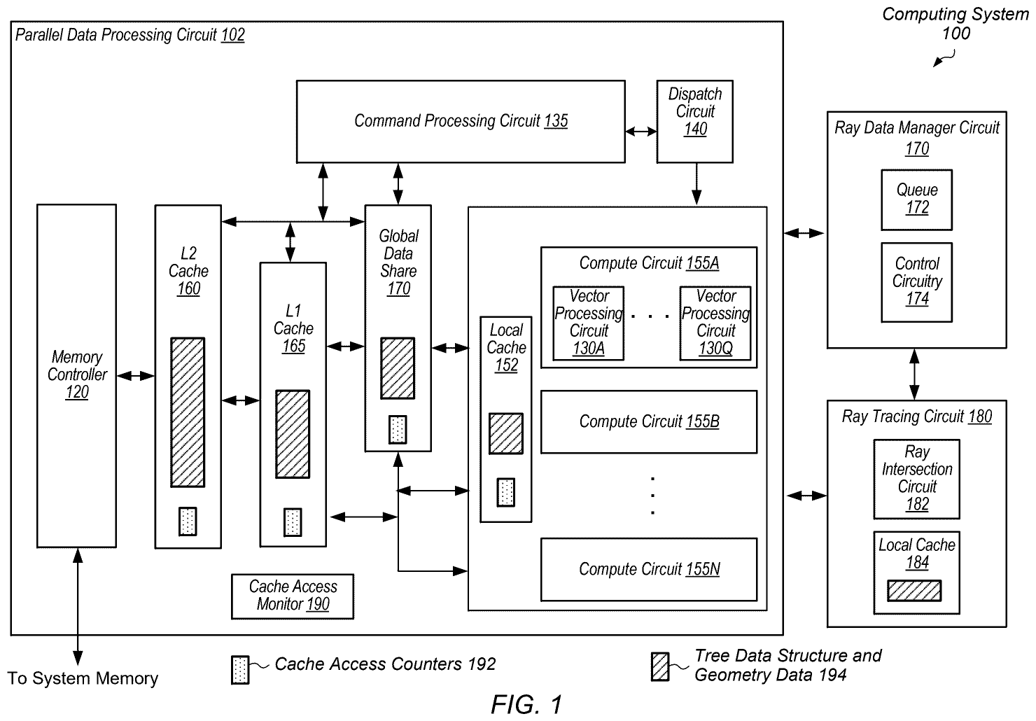

Turning now to FIG. 1, a block diagram is shown of a computing system 100 that efficiently manages ray tracing to reduce cache contention. In various implementations, apparatus 100 includes parallel data processing circuit 102 with an interface to system memory. In an implementation, parallel data processing circuit 102 is a graphics processing unit (GPU). In various implementations, apparatus 100 executes any of various types of highly parallel data applications. As part of executing an application, a host CPU (not shown) launches kernels to be executed by the parallel data processing circuit 102.

Multiple processes of a parallel data application provide work to be executed on compute circuits 155A-155N. The parallel data processing circuit 102 includes at least the command processing circuit (or command processor) 135, dispatch circuit 140, compute circuits 155A-155N, memory controller 120, global data share 168, shared level one (L1) cache 361, and level two (L1) cache 160. It should be understood that the components and connections shown for the parallel data processing circuit 102 are merely representative of one type processing circuit and does not preclude the use of other types of processing circuits for implementing the techniques presented herein. The apparatus 100 also includes other components which are not shown to avoid obscuring the figure. In other implementations, the parallel data processing circuit 102 includes other components, omits one or more of the illustrated components, has multiple instances of a component even if only one instance is shown in the apparatus 100, and/or is organized in other suitable manners. Also, each connection shown in apparatus 100 is representative of any number of connections between components. Additionally, other connections can exist between components even if these connections are not explicitly shown in apparatus 100.

The command processing circuit 135 receives kernels from the host CPU and determines when dispatch circuit 140 dispatches wavefronts of these kernels to the compute circuits 155A-155N. A particular combination of the same instruction and a particular data item of multiple data items is referred to as a “work item.” A work item is also referred to as a thread. The multiple work items (or multiple threads) are grouped into “wavefronts” or “waves.” In some implementations, a wavefront is a partition of work that includes instructions of a function call operating on multiple data items concurrently. Each data item is processed independently of other data items, but the same sequence of operations of the subroutine is used. A “workgroup” includes two or more wavefronts. The command processing circuit 135 or a scheduler in the compute circuits 155A-155N divides the workgroups into separate wavefronts, which are dispatched to the vector processing circuits 130A-130Q. A vector processing circuit can also be referred to as a single instruction multiple data (SIMD) circuit. Each of the vector processing circuits 130A-130Q includes multiple parallel execution lanes, each for executing a corresponding thread.

In an implementation, the memory controller 120 includes circuitry for supporting communication protocols and queues for storing requests and responses. Threads within wavefronts executing on compute circuits 155A-155N read data from and write data to the cache 152, vector general-purpose registers, scalar general-purpose registers, and when present, the global data share 168, the shared L1 cache 165, and the L1 cache 160. When present, it is noted that the shared L1 cache 165 can include separate structures for data and instruction caches. It is also noted that global data share 168, shared L1 cache 165, L1 cache 160, memory controller 120, system memory, and cache 152 can collectively be referred to herein as a “cache memory subsystem”. In various implementations, the circuitry of compute circuit 155B is an instance of the circuitry of compute circuit 155A (i.e., circuitry having the same design). In some implementations, each of the compute circuits 155A-155N is a “chiplet.” A chiplet is a semiconductor die (or die) fabricated separately from other dies, and then interconnected with these other dies to form a single integrated circuit.

In an implementation, cache 152 represents a last level shared cache structure such as a local level-two (L1) cache within partition 150A. Additionally, each of the multiple compute circuits 155A-155N includes vector processing circuits 130A-130Q, each with circuitry of multiple parallel computational lanes of simultaneous execution. These parallel computational lanes operate in lockstep. In various implementations, the data flow within each of the lanes is pipelined. Pipeline registers are used for storing intermediate results and circuitry for arithmetic logic units (ALUs) perform integer arithmetic, floating-point arithmetic, Boolean logic operations, branch condition comparisons and so forth. These components are not shown for ease of illustration. Each of the ALUs within a given row across the lanes includes the same circuitry and functionality, and operates on the same instruction, but different data, such as a different data item, associated with a different thread. In addition to the vector processing circuits 130A-130Q, compute circuit 155A also includes at least an assigned number of vector general-purpose registers (VGPRs) per thread, an assigned number of scalar general-purpose registers (SGPRs) per wavefront, and an assigned data storage space of a local data store per workgroup.

The cache access counters 192 are used to track cache access metrics of the cache memory subsystem of parallel data processing circuit 102. Examples of the cache access metrics are cache evictions, cache misses, and cache access latencies. Cache access counters 192 can be used for each level of the cache memory subsystem or used for selected one or more levels of the cache memory subsystem. Cache access monitor 190 accesses the counts of the cache access counters 192 and divides the counts by a count of clock cycles or other measurement of time to generate a cache miss rate, a cache eviction rate, and average cache access latency of one or more levels of the cache memory subsystem. In some implementations, cache access monitor 190 compares these metrics with corresponding thresholds. In other implementations, the ray data manager circuit 170 tracks time, generates the rates and averages, and performs comparisons with corresponding thresholds.

Ray tracing manager circuit 170 receives ray data corresponding to rays from compute circuits 155A-155N. In various implementations, queues (e.g., queue 172) or other memory structure are used to store the received ray data. The ray intersection circuit 182 of ray tracing circuit 180 performs ray intersection operations using the data 194 of the multi-node tree data structure and geometry data and rays stored in queue 172 to perform ray intersection operations. As shown, copies of this data 194 are stored in the cache memory subsystem of parallel data processing circuit 102. The local cache 184 of ray tracing circuit 180 stores a local copy of a subset of data 194. Control circuitry of ray tracing manager circuit 170 generates a limit (or a threshold) of a number of rays that the compute circuits 155A-155N convey to the ray tracing circuit 180 for processing based on the cache access metrics. By doing so, the number of rays concurrently processed by ray tracing circuit 180 is reduced to no more than the limit (threshold). Examples of the cache access metrics are the cache miss rate, the cache eviction rate, and the average cache access latency of one or more levels of the cache memory subsystem of parallel data processing circuit 102. In some implementations, the limit is a rate of a number of rays to write per unit time. In other implementations, the limit is number of rays that can be stored in queue 172. In other implementations, the limit can be set differently as desired.

To generate the limit, control circuitry 174 compares one or more of the cache metrics to a corresponding threshold and if any of the cache eviction rate, cache miss rate and cache access latency exceed its corresponding threshold, then control circuitry 174 reduces (or “throttles”) the number of rays being processed by the ray tracing circuit by reducing the number of rays conveyed to the ray tracing circuit for processing. For example, control circuitry 174 reduces the limit of the number of rays that the compute circuits 155A-155N can send to queue 172. Therefore, the ray tracing circuit 180 processes fewer rays than before. Otherwise, if none of the cache eviction rate, cache miss rate and cache access latency exceed its corresponding threshold (or otherwise falls below some threshold), then control circuitry 174 increases the number of rays being processed by the ray tracing circuit 180. If cache metrics continue to indicate cache contention, then the number of rays may be progressively reduced further. For example, control circuitry 174 increases the limit of the number of rays that the compute circuits 155A-155N can send to queue 172. Therefore, the ray tracing circuit 180 processes more rays than before. In other implementations, a weighted sum of the cache access metrics is generated by control circuitry 174 and compared to a corresponding threshold to set the limit.

In yet other implementations, a performance monitor circuit (not shown) monitor performance (e.g., based on performance counters or other mechanisms), such as a rate or throughput, of rendering video frames. If the performance is greater than a corresponding performance threshold, then control circuitry 174 updates the set of thresholds used for comparisons with the cache access metrics. For example, if the performance increases, control circuitry 174 increases one or more thresholds of the set of thresholds. Otherwise, if the performance is less than or equal to the performance threshold, then control circuitry 174 maintains the set of thresholds. In other implementations, if the performance is less than or equal to the performance threshold, then control circuitry 174 reduces one or more thresholds of the set of thresholds. It is noted that while the present description discusses video graphics workloads and the use of the ray tracing circuit 180, the methods and mechanisms described herein are not limited to such a context. In other implementations, the methods and mechanisms can be used with other types of data processing with tasks or threads of execution performing memory accesses. For example, neural network related processing, machine learning, database accesses, and so on, can all benefit from the methods and mechanisms described herein. In such cases, cache efficiency is improved and overall processing rates may likewise be improved. Various such alternatives are possible and are contemplated. As used herein, when discussing a “ray” the ray may be referred to as corresponding to a different task or thread of execution. However, it is to be understood that in various implementations the ray tracing circuitry is configured to process the received rays in a variety of ways including one ray per thread, using a thread pool to process rays, using tasks to distribute work to available threads, and so on. Numerous such implementations are possible and are contemplated.

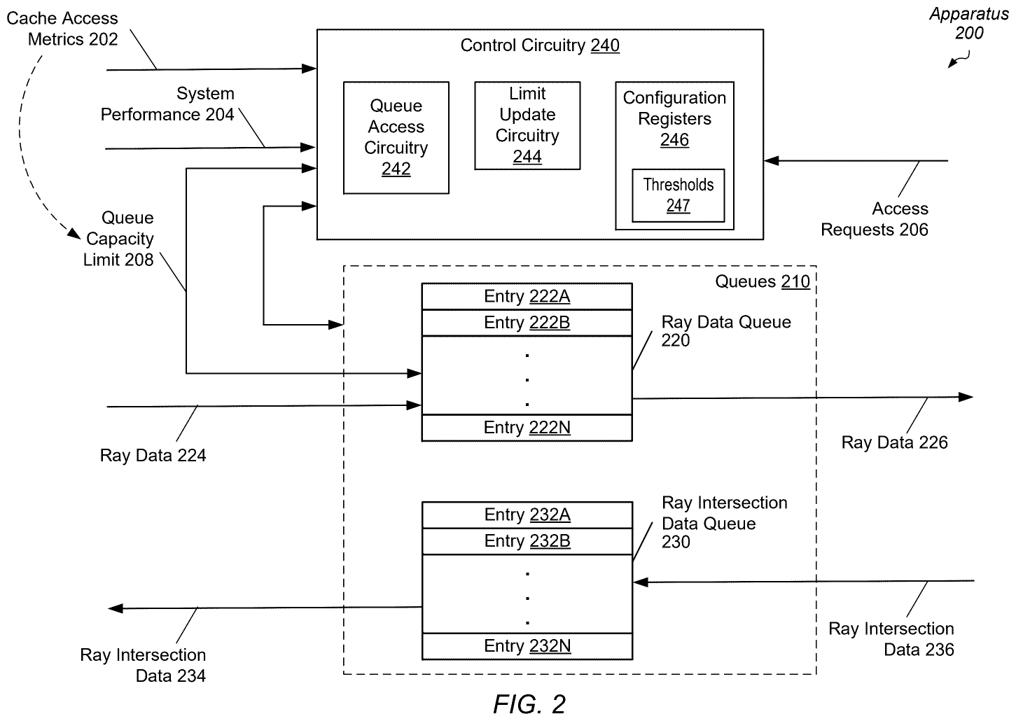

Turning now to FIG. 2, a generalized diagram is shown of an apparatus 200 that efficiently manages ray tracing to reduce cache contention. As shown, apparatus 200 includes queues 210 and the control circuitry 240. In some implementations, control circuitry 240 receives cache access metrics 202, and using these metrics, generates the queue capacity limit 208 for ray data queue 220 of queues 210. The control circuitry 240 includes queue access circuitry 242, limit update circuitry 244, and configuration registers 246 that store at least one or more thresholds 247. Control circuitry 240 also receives access requests 206 for data stored in one of ray data queue 220 and ray intersection data queue 230.

Ray data queue 220 stores information corresponding to generated simulated light rays (or rays) in the entries 212A-212N. Ray data queue 220 is implemented with one of flip-flop circuits, one of a variety of types of a random-access memory (RAM), a content addressable memory (CAM), or other. Ray intersection data queue 230 is implemented in a similar manner in various implementations. Ray intersection data queue 230 stores output ray intersection data generated by a ray tracing circuit. In some implementations, compute circuits of a parallel data processing circuit store ray data 224 in ray data queue 220 and the ray tracing circuit accesses the ray data 226 from ray data queue 220, whereas the ray tracing circuit stores ray intersection data 234 in ray intersection data queue 230 and the compute circuits of the parallel data processing circuit accesses the ray intersection data 236 in ray intersection data queue 230. Based on access requests 206, queue access circuitry 242 controls access of the ray data queue 220 and the ray intersection data queue 230. In other implementations, queue access circuitry 242 accesses queues 210 based on synchronized operations or other criteria without waiting for access requests 206.

The values stored in the configuration registers 246 can be read from flip-flop circuits, one of a variety of types of a ROM, one of a variety of types of a random-access memory (RAM), a content addressable memory (CAM), or others. In various implementations, configuration registers 246 include programmable registers. In some implementations, limit update circuitry 244 generates a weighted sum based on the cache access metrics 202 and compares the weighted sum to a corresponding threshold of thresholds 247. The comparisons are used to generate the queue capacity limit 208 for ray data queue 220. Limit update circuitry 244 generates queue capacity limit 208 based on the cache access metrics 202 such as the cache miss rate, the cache eviction rate, and the average cache access latency of one or more levels of the cache memory subsystem of a parallel data processing circuit.

In some implementations, if any of the cache eviction rate, cache miss rate and cache access latency of cache access metrics 202 exceed its corresponding threshold of thresholds 247, then limit update circuitry 244 reduces the number of rays being processed by the ray tracing circuit. For example, limit update circuitry 244 reduces the queue capacity limit 208. Therefore, the ray tracing circuit processes fewer rays than before. Otherwise, if none of the cache eviction rate, cache miss rate and cache access latency of cache access metrics 202 exceed its corresponding threshold of thresholds 247, then limit update circuitry 244 increases the number of rays being processed by the ray tracing circuit. For example, limit update circuitry 244 increases the queue capacity limit 208. Therefore, the ray tracing circuit processes more rays than before. In other implementations, a weighted sum of the cache access metrics is generated by limit update circuitry 244 using weight values stored in configuration registers 246 and compared to a corresponding threshold to set the queue capacity limit 208.

In yet other implementations, a performance monitor circuit accesses hardware performance counters to monitor performance, such as a rate or throughput, of rendering video frames and sends system performance 204 to control circuitry 240. If the performance is greater than a corresponding threshold of thresholds 247, then limit update circuitry 244 updates the set of thresholds. For example, if the performance increases, limit update circuitry 244 increases the thresholds. Otherwise, if the performance is less than or equal to the threshold, then limit update circuitry 244 maintains the set of thresholds.

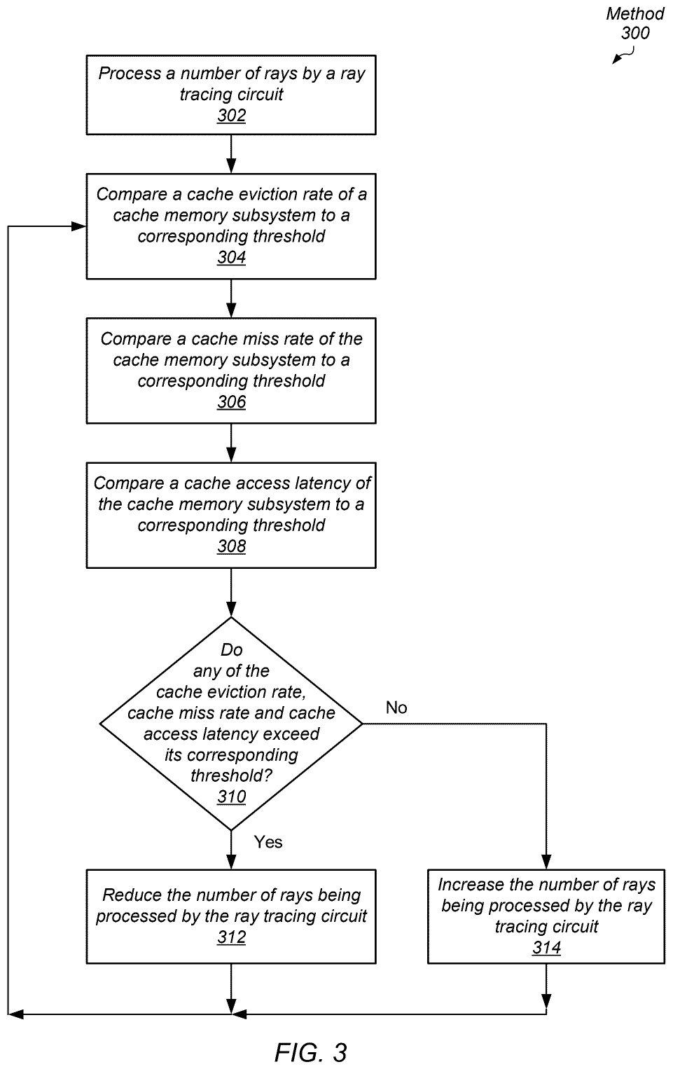

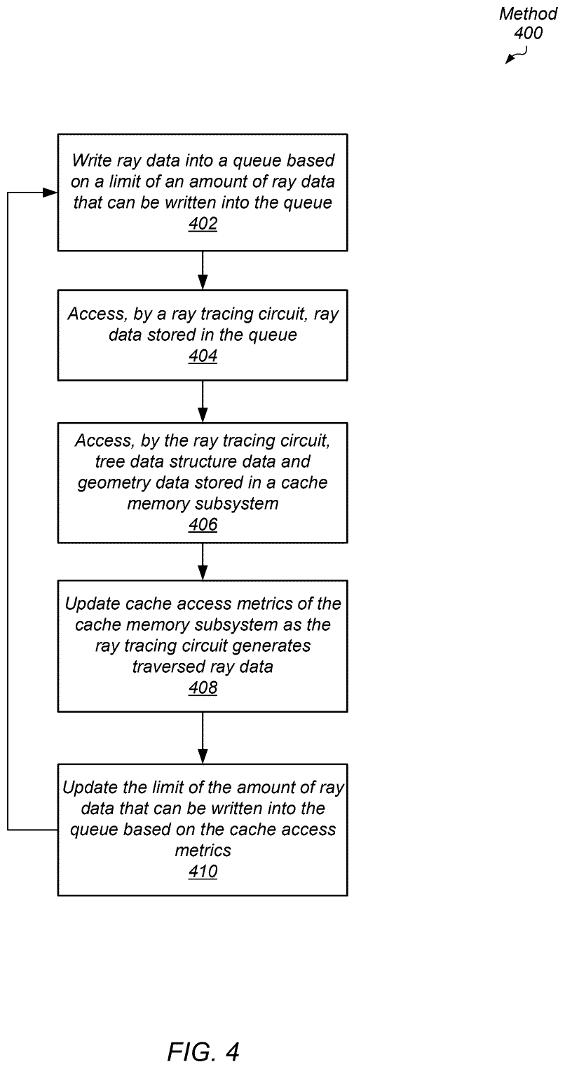

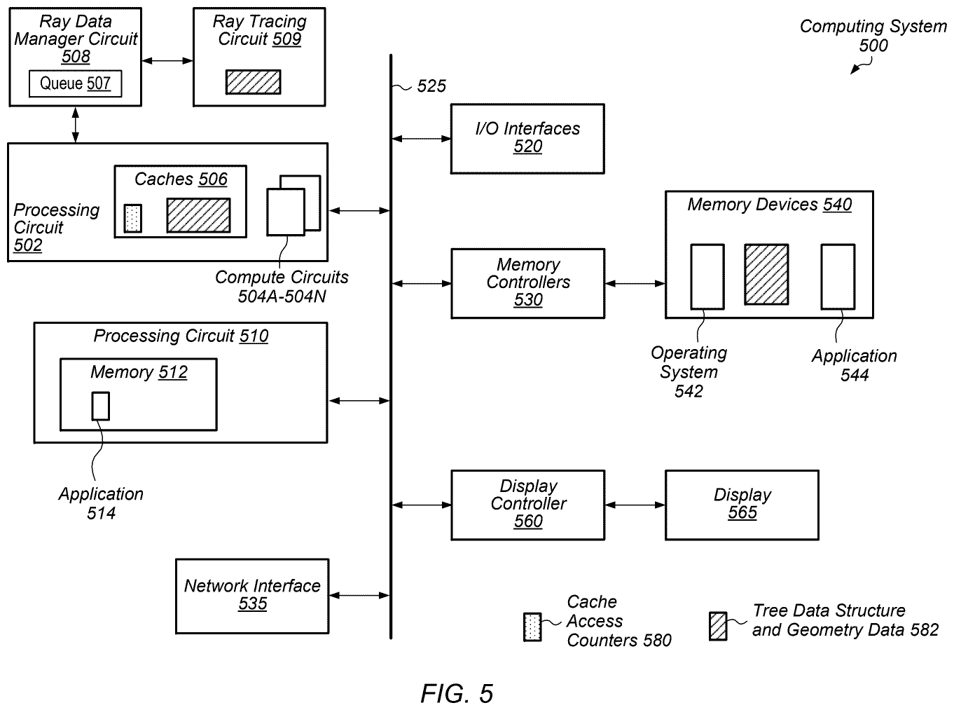

For the methods 300-400 (of FIGS. 3-4), a computing system includes multiple processing circuits. A host processing circuit of the multiple processing circuits is a general-purpose processing circuit, such as a central processing unit (CPU). Another processing circuit of the multiple processing circuits is a parallel data processing circuit with a highly parallel data microarchitecture. Examples of this processing circuit are a graphics processing unit (GPU), a digital signal processing circuit (DSP), a field programmable gate arrays (FPGA), and an application specific integrated circuit (ASIC). In some implementations, the host processing circuit has the functionality of processing circuit 510 (of FIG. 5) and the parallel data processing circuit has the functionality of parallel processing circuit 102 (of FIG. 1) and processing circuit 502 (of FIG. 5). The parallel data processing circuit communicates with a ray tracing circuit via a ray data manager circuit. In some implementations, the ray tracing circuit has the functionality of ray tracing circuit 180 (of FIG. 1) and ray tracing circuit 509 (of FIG. 5), and the ray data manager circuit has the functionality of the ray data manager circuit 170 (of FIG. 1), the apparatus 200 (of FIG. 2), and the ray data manager circuit 508 (of FIG. 5).

In various implementations, the host processing circuit converts (translates) the instructions of a highly parallel data application, such as a video graphics application, to commands. The host processing circuit stores the commands in a buffer (e.g., a ring buffer, or otherwise) in system memory. The parallel data processing circuit reads the commands from the buffer. A cache access monitor tracks one or more of a cache miss rate, a cache eviction rate and an average cache access latency of one or more levels of a cache memory subsystem of the parallel data processing circuit. A ray data manager circuit controls data transfer of ray data and ray intersection data between the parallel data processing circuit and a ray tracing circuit based on feedback from the cache access monitor.

Referring to FIG. 3, a generalized block diagram is shown of a method 300 for efficiently managing ray tracing to reduce cache contention. For purposes of discussion, the steps in this implementation (as well as FIGS. 4 and 6-9) are shown in sequential order. However, in other implementations some steps occur in a different order than shown, some steps are performed concurrently, some steps are combined with other steps, and some steps are absent.

The ray tracing circuit processes a number of rays (block 302). As described earlier, the ray tracing circuit generates ray intersection data based on rays generated by compute circuits of the parallel data processing circuit and data of the multi-node tree data structure representing geometric shapes of objects in a scene of a video frame. The cache access monitor circuit compares the cache eviction rate of a cache memory subsystem to a corresponding threshold (block 304). The cache access monitor circuit compares a cache miss rate of the cache memory subsystem to a corresponding threshold (block 306). The cache access monitor circuit compares the cache access latency of the cache memory subsystem to a corresponding threshold (block 308).

If any of the cache eviction rate, cache miss rate and cache access latency exceed its corresponding threshold (“yes” branch of the conditional block 310), then the computing system reduces the number of rays being processed by the ray tracing circuit (block 312). For example, the ray data manager circuit reduces a limit of the number of rays that the compute circuits can send to the ray data manager circuit. By doing so, the number of rays concurrently processed by the ray tracing circuit is reduced to no more than the limit (threshold). Therefore, the ray tracking circuit processes fewer rays than before. Otherwise, if none of the cache eviction rate, cache miss rate and cache access latency exceed its corresponding threshold (“no” branch of the conditional block 310), then the computing system increases the number of rays being processed by the ray tracing circuit (block 314). For example, the ray data manager circuit increases a limit of the number of rays that the compute circuits can send to the ray data manager circuit. Therefore, the ray tracking circuit processes more rays than before. Afterward, control flow of method 300 returns to block 304 where the cache access monitor circuit compares a cache eviction rate of a cache memory subsystem to a corresponding threshold.

Turning now to FIG. 4, a generalized block diagram is shown of a method 400 for efficiently managing ray tracing to reduce cache contention. The compute circuits of the parallel data processing circuit write ray data into a queue based on a limit of an amount of ray data that can be written into the queue (block 402). The ray tracing circuit accesses the ray data stored in the queue (block 404). The ray tracing circuit accesses geometry data stored in a cache memory subsystem (block 406). For example, the cache memory subsystem of the parallel data processing circuit stores data of the multi-node tree data structure. The cache access monitor circuit updates cache access metrics of the cache memory subsystem as the ray tracing circuit generates traversed ray data (block 408). The traversed output ray data includes ray intersection data. The ray data manager circuit updates the limit of the amount of ray data that can be written into the queue based on the cache access metrics (block 410). Afterward, control flow of method 400 returns to block 402 where the compute circuits of the parallel data processing circuit write ray data into a queue based on a limit of an amount of ray data that can be written into the queue.

Turning now to FIG. 5, a generalized diagram is shown of a computing system 500 that efficiently manages ray tracing to reduce cache contention. In an implementation, computing system 500 includes at least processing circuits 502 and 510, ray data manager circuit 508, ray tracing circuit 509, input/output (I/O) interfaces 520, bus 525, network interface 535, memory controllers 530, memory devices 540, display controller 560, and display 565. In other implementations, computing system 500 includes other components and/or computing system 500 is arranged differently. For example, power management circuitry, and phased locked loops (PLLs) or other clock generating circuitry are not shown for ease of illustration. In various implementations, the components of the computing system 500 are on the same die such as a system-on-a-chip (SOC). In other implementations, the components are individual dies in a system-in-package (SiP) or a multi-chip module (MCM). A variety of computing devices use the computing system 500 such as a desktop computer, a laptop computer, a server computer, a tablet computer, a smartphone, a gaming device, a smartwatch, and so on.

Processing circuits 502 and 510 are representative of any number of processing circuits which are included in computing system 500. In an implementation, processing circuit 510 is a general-purpose central processing unit (CPU). In one implementation, processing circuit 502 is a parallel data processing circuit with a highly parallel data microarchitecture, such as a GPU. The processing circuit 502 can be a discrete device, such as a dedicated GPU (dGPU), or the processing circuit 502 can be integrated (an iGPU) in the same package as another processing circuit. Other parallel data processing circuits that can be included in computing system 500 include digital signal processing circuits (DSPs), field programmable gate arrays (FPGAs), application specific integrated circuits (ASICs), and so forth.

In various implementations, the processing circuit 502 includes multiple, replicated compute circuits 504A-504N, each including similar circuitry and components such as single instruction multiple data (SIMD) circuits, the caches 506, and hardware resources (not shown). Caches 506 represent the cache memory subsystem of processing circuit 502. The SIMD circuits of the compute circuits 504A-504N includes multiple, parallel computational lanes. In various implementations, the SIMD circuits have the same functionality as the vector processing circuits 130A-130Q (of FIG. 1) and the compute circuits 504A-504N have the same functionality as compute circuits 155A-155N. Similarly, processing circuit 502 has the same functionality as parallel processing circuit 102 (of FIG. 1), queue 507 has the same functionality as queue 172 (of FIG. 1) and queue 220 (of FIG. 2), ray data manager circuit 508 has the same functionality as ray data manager circuit 170 (of FIG. 1) and apparatus 200 (of FIG. 2), and ray tracing circuit 509 has the same functionality as ray tracing circuit 180 (of FIG. 1). The cache access counters 580 are used to track cache access metrics of caches 506. Ray tracing circuit 509 uses the data 582 of the multi-node tree data structure and geometry data to perform ray intersection operations. Copies of this data 582 are stored in caches 506.

In some implementations, each of the application 544 stored on the memory devices 540 and its copy (application 514) stored on the memory 512 is a highly parallel data application such as a video graphics application. The highly parallel data application includes function calls that allow the developer to insert requests in the highly parallel data application for launching wavefronts of a kernel (function call). In various implementations, processing circuit 510 converts (translates) the instructions of the highly parallel data application to commands. In various implementations, the processing circuit 510 stores the commands in a buffer in system memory provided by memory devices 540. Processing circuit 502 reads the commands from the buffer in the system memory provided by memory devices 540. In an implementation, the buffer includes multiple storage locations of the memory devices 540 used to provide a memory mapped input/output (MMIO) first-in-first-out (FIFO) buffer. The high parallelism offered by the hardware of the compute circuits 504A-504N is used for real-time data processing. Examples of real-time data processing are rendering multiple pixels, image blending, pixel shading, vertex shading, and geometry shading. In such cases, each of the data items of a wavefront is a pixel of an image.

Memory 512 represents a local hierarchical cache memory subsystem. Memory 512 stores source data, intermediate results data, results data, and copies of data and instructions stored in memory devices 540. Processing circuit 510 is coupled to bus 525 via interface 506. Processing circuit 510 receives, via interface 506, copies of various data and instructions, such as the operating system 542, one or more device drivers, one or more applications such as application 504, and/or other data and instructions. The processing circuit 510 retrieves a copy of the application 544 from the memory devices 540, and the processing circuit 510 stores this copy as application 514 in memory 512.

In some implementations, computing system 500 utilizes a communication fabric (“fabric”), rather than the bus 525, for transferring requests, responses, and messages between the processing circuits 502 and 510, the I/O interfaces 520, the memory controllers 530, the network interface 535, and the display controller 550. When messages include requests for obtaining targeted data, the circuitry of interfaces within the components of computing system 500 translates target addresses of requested data. In some implementations, the bus 525, or a fabric, includes circuitry for supporting communication, data transmission, network protocols, address formats, interface signals and synchronous/asynchronous clock domain usage for routing data.

Memory controllers 530 are representative of any number and type of memory controllers accessible by processing circuits 502 and 510. While memory controllers 530 are shown as being separate from processing circuits 502 and 510, it should be understood that this merely represents one possible implementation. In other implementations, one of memory controllers 530 is embedded within one or more of processing circuits 502 and 510 or it is located on the same semiconductor die as one or more of processing circuits 502 and 510. Memory controllers 530 are coupled to any number and type of memory devices 540.

Memory devices 540 are representative of any number and type of memory devices. For example, the type of memory in memory devices 540 includes Dynamic Random Access Memory (DRAM), Static Random Access Memory (SRAM), NAND Flash memory, NOR flash memory, Ferroelectric Random Access Memory (FeRAM), or otherwise. Memory devices 540 store at least instructions of an operating system 542, one or more device drivers, and application 504. In some implementations, application 504 is a highly parallel data application such as a video graphics application, a shader application, or other. Copies of these instructions can be stored in a memory or cache device local to processing circuit 510 and/or processing circuit 502.

I/O interfaces 520 are representative of any number and type of I/O interfaces (e.g., peripheral component interconnect (PCI) bus, PCI-Extended (PCI-X), PCIE (PCI Express) bus, gigabit Ethernet (GBE) bus, universal serial bus (USB). Various types of peripheral devices (not shown) are coupled to I/O interfaces 520. Such peripheral devices include (but are not limited to) displays, keyboards, mice, printers, scanners, joysticks or other types of game controllers, media recording devices, external storage devices, and so forth. Network interface 535 receives and sends network messages across a network.

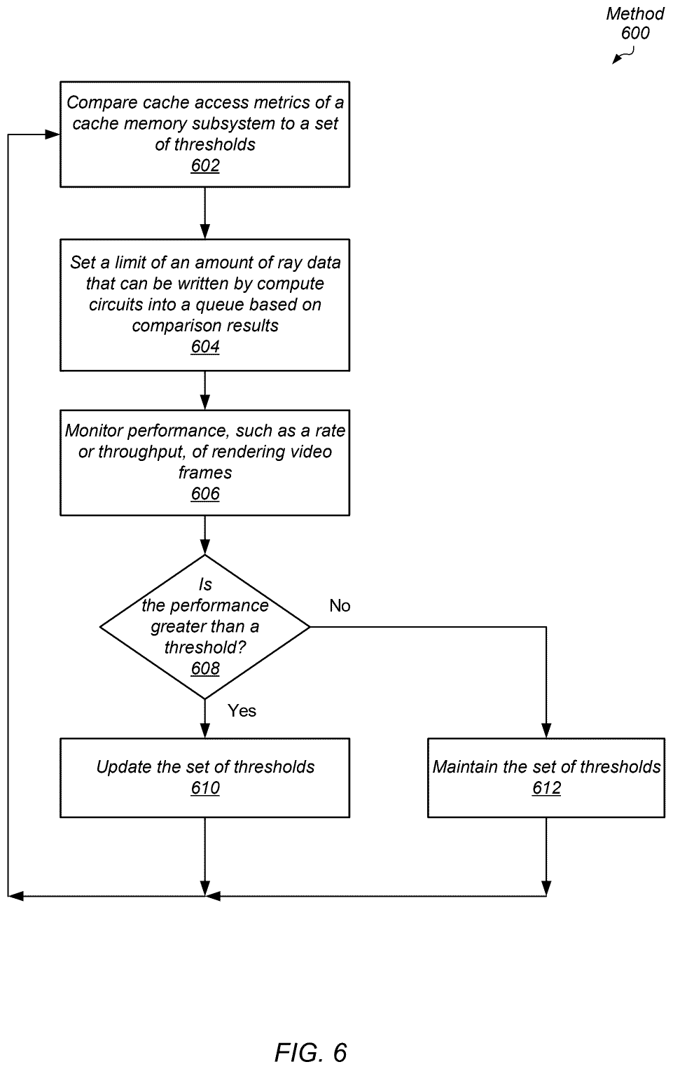

For the methods 600-900 (of FIGS. 6-9), a computing system includes multiple processing circuits. A host processing circuit of the multiple processing circuits is a general-purpose processing circuit, such as a central processing unit (CPU). Another processing circuit of the multiple processing circuits is a parallel data processing circuit with a highly parallel data microarchitecture. Examples of this processing circuit are a graphics processing unit (GPU), a digital signal processing circuit (DSP), a field programmable gate arrays (FPGA), and an application specific integrated circuit (ASIC). In some implementations, the host processing circuit has the functionality of processing circuit 510 (of FIG. 5) and the parallel data processing circuit has the functionality of parallel processing circuit 102 (of FIG. 1) and processing circuit 502 (of FIG. 5). The parallel data processing circuit communicates with a ray tracing circuit via a ray data manager circuit. In some implementations, the ray tracing circuit has the functionality of ray tracing circuit 180 (of FIG. 1) and ray tracing circuit 509 (of FIG. 5), and the ray data manager circuit has the functionality of the ray data manager circuit 170 (of FIG. 1), the apparatus 200 (of FIG. 2), and the ray data manager circuit 508 (of FIG. 5).

In various implementations, the host processing circuit converts (translates) the instructions of a highly parallel data application, such as a video graphics application, to commands. The host processing circuit stores the commands in a buffer in system memory. The parallel data processing circuit reads the commands from the buffer. A cache access monitor tracks one or more of a cache miss rate, a cache eviction rate and an average cache access latency of one or more levels of a cache memory subsystem of the parallel data processing circuit. A ray data manager circuit controls data transfer of ray data and ray intersection data between the parallel data processing circuit and a ray tracing circuit based on feedback from the cache access monitor.

Referring to FIG. 6, a generalized block diagram is shown of a method 600 for efficiently managing ray tracing to reduce cache contention. For purposes of discussion, the steps in this implementation (as well as FIGS. 3-4 and 7-9) are shown in sequential order. However, in other implementations some steps occur in a different order than shown, some steps are performed concurrently, some steps are combined with other steps, and some steps are absent. One or more of a cache access monitor circuit and the ray data manager circuit compares cache access metrics of a cache memory subsystem to a set of thresholds (block 602). The ray data manager circuit sets a limit of an amount of ray data that can be written by compute circuits into a queue based on the comparison results (block 604). By doing so, the number of rays concurrently processed by the ray tracing circuit is reduced to no more than the limit (threshold). A performance monitor circuit accesses hardware performance counters to monitor performance, such as a rate or throughput, of rendering video frames or performing a variety of other types of parallel data workloads (block 606). If the performance is greater than a threshold (“yes” branch of the conditional block 608), then the ray data manager circuit updates the set of thresholds (block 610). For example, if the performance increases, the ray tracking manager circuit increases the thresholds. Otherwise, if the performance is less than or equal to the threshold (“no” branch of the conditional block 608), then the ray tracking manager circuit maintains the set of thresholds (block 612). Afterward, control flow of method 600 returns to block 602 where one or more of a cache access monitor circuit and the ray data manager circuit compares cache access metrics of a cache memory subsystem to a set of thresholds.

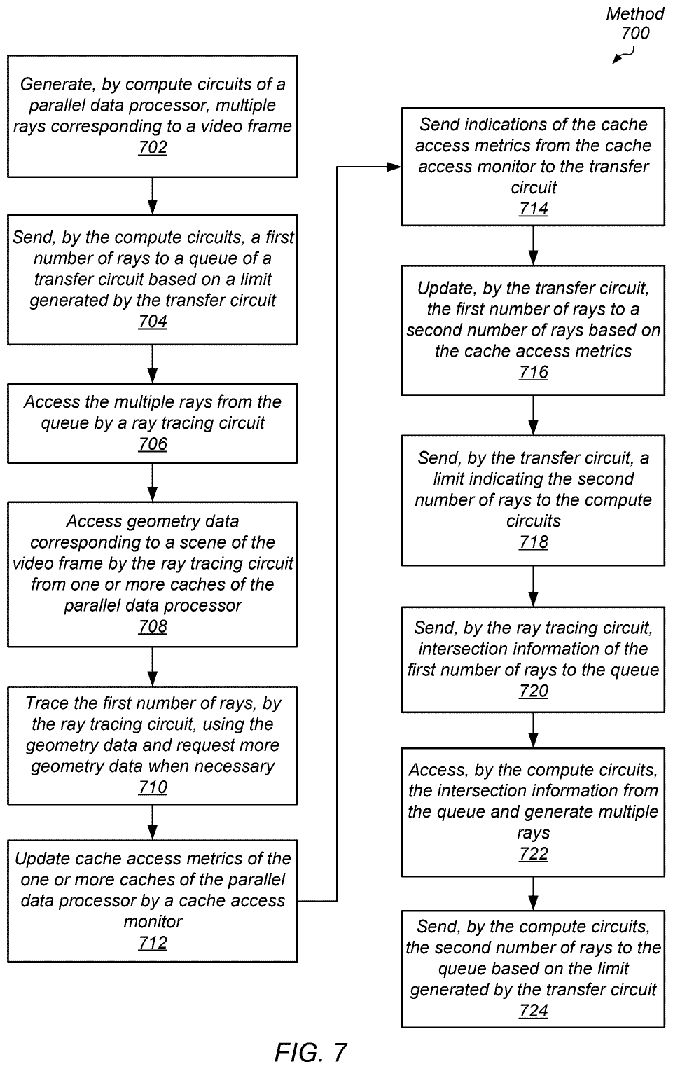

Turning now to FIG. 7, a generalized block diagram is shown of a method 700 for efficiently managing ray tracing to reduce cache contention. Compute circuits of a parallel data processor generates multiple rays corresponding to a video frame (block 702). The compute circuits send a first number of rays to a queue of a transfer circuit, such as the ray data manager circuit, based on a limit generated by the transfer circuit (block 704). The ray tracing circuit accesses the multiple rays from the queue (block 706). The ray tracing circuit accesses geometry data corresponding to a scene of the video frame by the ray tracing circuit from one or more caches of the parallel data processor (block 708). The ray tracing circuit traces the first number of rays using the geometry data and request more geometry data when necessary (block 710).

The cache access monitor circuit updates cache access metrics of the one or more caches of the parallel data processor (block 712). The cache access monitor sends indications of the cache access metrics to the transfer circuit (block 714). The transfer circuit, such as the ray data manager circuit, updates the first number of rays to a second number of rays based on the cache access metrics (block 716). The transfer circuit sends a limit indicating the second number of rays to the compute circuits (block 718). The ray tracing circuit sends intersection information of the first number of rays to the queue (block 720). The compute circuits access the intersection information from the queue and generate multiple rays (block 722). The compute circuits send the second number of rays to the queue based on the limit generated by the transfer circuit (block 724).

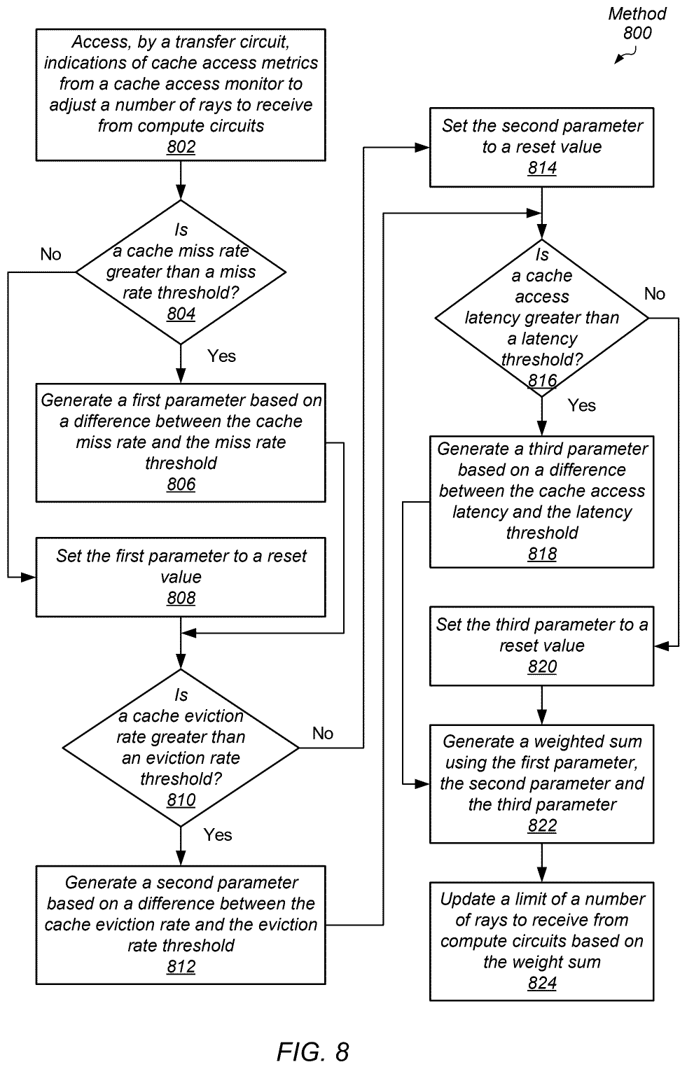

Referring to FIG. 8, a generalized block diagram is shown of a method 800 for efficiently managing ray tracing to reduce cache contention. The transfer circuit, such as the ray data manager circuit, accesses indications of cache access metrics from a cache access monitor to adjust a number of rays to receive from compute circuits (block 802). If a cache miss rate is greater than a miss rate threshold (“yes” branch of the conditional block 804), then the ray data manager circuit generates a first parameter based on a difference between the cache miss rate and the miss rate threshold (block 806). Otherwise, if the cache miss rate is less than or equal to the miss rate threshold (“no” branch of the conditional block 804), then the ray data manager circuit sets the first parameter to a reset value (block 808).

If a cache eviction rate is greater than an eviction rate threshold (“yes” branch of the conditional block 810), then the ray data manager circuit generates a second parameter based on a difference between the cache eviction rate and the eviction rate threshold (block 812). Otherwise, if the cache miss rate is less than or equal to the miss rate threshold (“no” branch of the conditional block 810), then the ray data manager circuit sets the second parameter to a reset value (block 814).

If a cache access latency is greater than a latency threshold (“yes” branch of the conditional block 816), then the ray data manager circuit generates a third parameter based on a difference between the cache access latency and the latency threshold (block 818). Otherwise, if the cache access latency is less than or equal to the latency threshold (“no” branch of the conditional block 810), then the ray data manager circuit sets the third parameter to a reset value (block 820). The ray data manager circuit generates a weighted sum using the first parameter, the second parameter and the third parameter (block 822). The ray data manager circuit updates a limit of a number of rays to receive from compute circuits based on the weight sum (block 824).

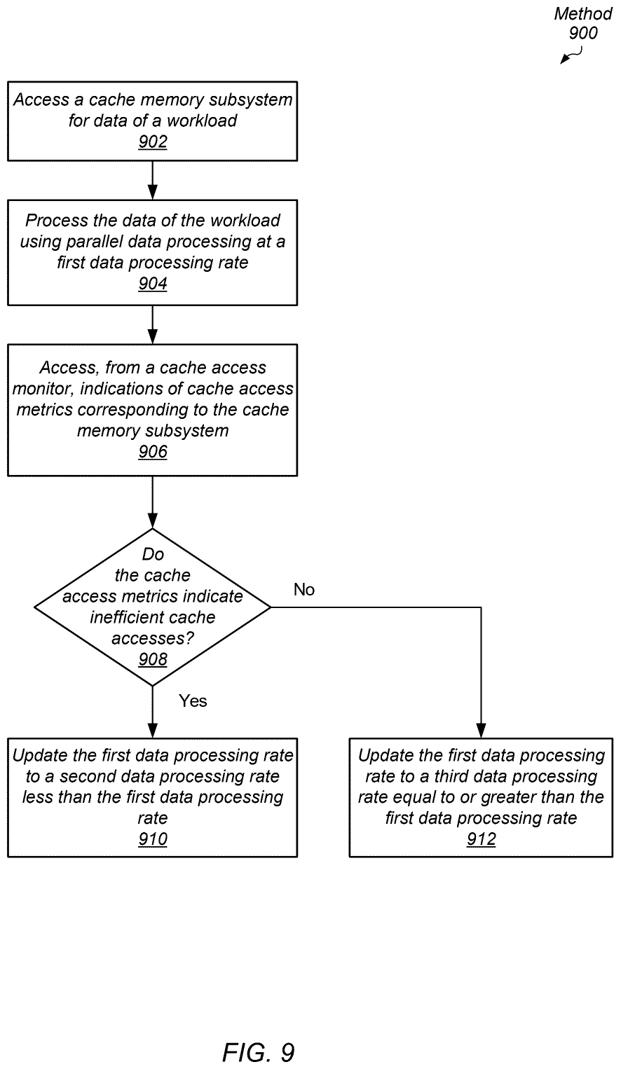

Referring to FIG. 9, a generalized block diagram is shown of a method 900 for efficiently managing parallel data processing to reduce cache contention. In various implementations, a workload is provided by a parallel data application and a host processing circuit converts (translates) the instructions of the highly parallel data application to commands. The parallel data application is used in a variety of fields such as entertainment, medicine, business, education, engineering, and so forth. The host processing circuit stores the commands in a buffer in system memory. A parallel data processing circuit reads the commands from the buffer and executes the workload by performing parallel data processing for the commands. During execution of the workload, the parallel data processing circuit accesses a cache memory subsystem for data of the workload (block 902).

The parallel data processing circuit processes the data of the workload using the parallel lanes of execution at a first data processing rate (block 904). In various implementations, compute circuits of the parallel data processing circuit uses the first data processing rate, which can be measured by an operating clock frequency, or by a number of commands dispatched or issued to parallel execution lanes. In some implementations, the workload is a video graphics workload, and a ray tracing circuit processes ray data using parallel data processing. The ray tracing circuit also uses the first data processing rate. In other implementations, no ray tracing circuit is used for other types of workloads that do not include a video graphics application. A cache access monitor accesses indications of cache access metrics corresponding to the cache memory subsystem (block 906). As described earlier, examples of the cache access metrics are a cache miss rate, a cache eviction rate, and an average cache latency.

If the cache access metrics indicate inefficient cache accesses (“yes” branch of the conditional block 908), then control circuitry updates the first data processing rate to a second data processing rate less than the first data processing rate (block 910). In some implementations, one or more of the control circuitry and the cache access monitor performs comparisons with corresponding thresholds and generates parameters to generate an indication of whether the cache memory subsystem has inefficient cache accesses. Steps performed in methods 300 and 800 (FIGS. 3 and 8) can be used to generate the indication. The inefficient cache accesses indicate a lack of one or more of spatial and temporal relationships of the data being requested from the cache memory subsystem. Reducing the data processing rate causes the operational clock frequency to be reduced or causes a number of commands to be dispatched or issued to the parallel lanes of execution to be reduced. Otherwise, if the cache access metrics do not indicate inefficient cache accesses (“no” branch of the conditional block 908), then the control circuitry updates the first data processing rate to a third data processing rate equal to or greater than the first data processing rate (block 912).

It is noted that one or more of the above-described implementations include software. In such implementations, the program instructions that implement the methods and/or mechanisms are conveyed or stored on a computer readable medium. Numerous types of media which are configured to store program instructions are available and include hard disks, floppy disks, CD-ROM, DVD, flash memory, Programmable ROMs (PROM), random access memory (RAM), and various other forms of volatile or non-volatile storage. Generally speaking, a computer accessible storage medium includes any storage media accessible by a computer during use to provide instructions and/or data to the computer. For example, a computer accessible storage medium includes storage media such as magnetic or optical media, e.g., disk (fixed or removable), tape, CD-ROM, or DVD-ROM, CD-R, CD-RW, DVD-R, DVD-RW, or Blu-Ray. Storage media further includes volatile or non-volatile memory media such as RAM (e.g., synchronous dynamic RAM (SDRAM), double data rate (DDR, DDR2, DDR3, etc.) SDRAM, low-power DDR (LPDDR2, etc.) SDRAM, Rambus DRAM (RDRAM), static RAM (SRAM), etc.), ROM, Flash memory, non-volatile memory (e.g., Flash memory) accessible via a peripheral interface such as the Universal Serial Bus (USB) interface, etc. Storage media includes microelectromechanical systems (MEMS), as well as storage media accessible via a communication medium such as a network and/or a wireless link.

Additionally, in various implementations, program instructions include behavioral-level descriptions or register-transfer level (RTL) descriptions of the hardware functionality in a high-level programming language such as C, or a design language (HDL) such as Verilog, VHDL, or database format such as GDS II stream format (GDSII). In some cases, the description is read by a synthesis tool, which synthesizes the description to produce a netlist including a list of gates from a synthesis library. The netlist includes a set of gates, which also represent the functionality of the hardware including the system. The netlist is then placed and routed to produce a data set describing geometric shapes to be applied to masks. The masks are then used in various semiconductor fabrication steps to produce a semiconductor circuit or circuits corresponding to the system. Alternatively, the instructions on the computer accessible storage medium are the netlist (with or without the synthesis library) or the data set, as desired. Additionally, the instructions are utilized for purposes of emulation by a hardware based type emulator from such vendors as Cadence®, EVE®, and Mentor Graphics®.

Although the implementations above have been described in considerable detail, numerous variations and modifications will become apparent to those skilled in the art once the above disclosure is fully appreciated. It is intended that the following claims be interpreted to embrace all such variations and modifications.

What is claimed is

1. An apparatus comprising:
circuitry configured to:
convey a plurality of data items for processing by processing circuitry; and
responsive to an indication of cache contention during processing by the processing circuitry, reduce a number of data items conveyed for processing by the processing circuitry.

2. The apparatus as recited in claim 1, wherein each of the plurality of data items corresponds to a different task or thread of execution.

3. The apparatus as recited in claim 1, wherein each of the plurality of data items corresponds to a ray generated based on image data.

4. The apparatus as recited in claim 3, wherein the circuitry is configured to progressively reduce a number of rays conveyed for processing, responsive to continued cache contention.

5. The apparatus as recited in claim 3, wherein the circuitry is configured to increase a number of rays conveyed for processing, responsive to cache contention falling below a threshold.

6. The apparatus as recited in claim 3, wherein responsive to the indication of cache contention, the circuitry is configured to reduce a number of rays concurrently processed by ray tracing circuitry to no more than a given threshold.

7. The apparatus as recited in claim 1, wherein the circuitry is configured to:
measure the cache contention by comparing one or more cache access metrics to a corresponding threshold; and
increase at least one threshold used to measure the cache contention based on performance of the processing circuitry exceeding a performance threshold.

8. A method, comprising:
accessing, by control circuitry, a cache memory subsystem for data of a workload;
conveying, by the control circuitry, a plurality of data items for processing by processing circuitry; and
responsive to an indication of cache contention during processing by the processing circuitry, reducing, by the control circuitry, a number of data items conveyed for processing by the processing circuitry.

9. The method as recited in claim 8, wherein each of the plurality of data items corresponds to a different task or thread of execution.

10. The method as recited in claim 8, wherein each of the plurality of data items corresponds to a ray generated based on image data.

11. The method as recited in claim 10, further comprising progressively reducing a number of rays conveyed for processing, responsive to continued cache contention.

12. The method as recited in claim 10, further comprising increasing a number of rays conveyed for processing, responsive to cache contention falling below a threshold.

13. The method as recited in claim 10, wherein responsive to the indication of cache contention, the method further comprises reducing a number of rays concurrently processed by ray tracing circuitry to no more than a given threshold.

14. The method as recited in claim 8, further comprising:
measuring the cache contention by comparing one or more cache access metrics to a corresponding threshold; and
increasing at least one threshold used to measure the cache contention based on performance of the processing circuitry exceeding a performance threshold.

15. A computing system comprising:
a cache memory subsystem comprising circuitry configured to store data of one or more workloads; and
processing circuitry; and
control circuitry configured to:
convey a plurality of data items for processing by the processing circuitry;
monitor cache access metrics during accesses of the cache memory subsystem; and
based at least in part on the cache access metrics, change a number of data items conveyed for processing by the processing circuitry.

16. The computing system as recited in claim 15, wherein each of the plurality of data items corresponds to a different task or thread of execution.

17. The computing system as recited in claim 15, wherein each of the plurality of data items corresponds to a ray generated based on image data.

18. The computing system as recited in claim 17, wherein the control circuitry is configured to progressively reduce a number of rays conveyed for processing, responsive to continued cache contention indicated by measurements of the cache access metrics.

19. The computing system as recited in claim 17, wherein the control circuitry is configured to increase a number of rays conveyed for processing, responsive to cache contention falling below a threshold, wherein the cache contention is indicated by measurements of the cache access metrics.

20. The computing system as recited in claim 17, wherein responsive to an indication of cache contention indicated by measurements of the cache access metrics, the control circuitry is configured to reduce a number of rays concurrently processed by ray tracing circuitry to no more than a given threshold.
